(19) United States
(12) Patent Application Publication
(10) Pub. No.: US 2025/0258341 A1
(43) Pub. Date: Aug. 14, 2025

(54) OPTICAL COUPLING BETWEEN STACKED CHIPS

(71) Applicant: GlobalFoundries U.S. Inc., Malta, NY (US)

(72) Inventors: UPPILI RAGHUNATHAN, Essex Junction, VT (US); VIBHOR JAIN, Clifton Park, NY (US); YVES NGU, Williston, VT (US); JOHNATAN KANTAROVSKY, South Burlington, VT (US); AJAY RAMAN, Essex Junction, VT (US); DENIZ ELIZABETH CIVAY, Waterford, NY (US); YUSHENG BIAN, Ballston Lake, NY (US); JEREMY MULDAVIN, Annandale, VA (US)

(21) Appl. No.: 18/442,072

(22) Filed: Feb. 14, 2024

(51) Int. Cl. G02B 6/293

(52) U.S. Cl. CPC G02B 6/29338

(57) ABSTRACT

A structure includes a first chip having a first surface and a second chip having a second surface adjacent to the first surface of the first chip. The first chip includes a first optical component and an optical waveguide protrusion adjacent to the first optical component. The optical waveguide protrusion extends above the first surface of the first chip. The second chip includes a second optical component and a groove adjacent to the second optical component. The groove extends from the second surface of the second chip and into a portion of the second chip. The optical waveguide protrusion is positioned in the groove in the second chip.

### TECHNICAL FIELD

The present disclosure relates generally to semiconductor devices, and more particularly to structures including stacked photonic chips and methods of forming structures including stacked photonic chips.

### BACKGROUND

A photonics chip, also known as an integrated photonics chip or photonic integrated circuit (PIC), is a semiconductor device that integrates various optical components and functions on a single chip or substrate. Photonics chips are finding applications in a wide range of fields, such as telecommunications, data communications, sensing, medical devices, and quantum computing, as they enable faster, more efficient, and higher capacity information processing and communication. As technology continues to advance towards increased functionality, there is a desire to integrate chips or wafers together. This integration, for example, can facilitate the creation of heterogeneous devices or systems, where different types of chips or wafers, including photonic chips or wafers, with specialized functions can be combined.

From the foregoing discussion, it is desirable to provide improved structures including stacked photonic chips and methods of forming thereof.

### SUMMARY

Embodiments generally relate to semiconductor devices and methods of forming thereof. According to various embodiments, a structure includes a first chip having a first surface, and including a first optical component and an optical waveguide protrusion adjacent to the first optical component. The optical waveguide protrusion extends above the first surface of the first chip. The structure further includes a second chip having a second surface adjacent to the first surface of the first chip. The second chip includes a second optical component and a groove adjacent to the second optical component. The groove may extend from the second surface of the second chip and into a portion of the second chip. The optical waveguide protrusion is positioned in the groove in the second chip.

According to another aspect, a structure includes a first chip and a second chip stacked over the first chip. The first chip includes a first optical waveguide, a second optical waveguide arranged on the first optical waveguide, and a first dielectric layer surrounding the first optical waveguide. The second optical waveguide extends above a top surface of the first dielectric layer. The second chip includes a second dielectric layer arranged over the first dielectric layer, a third optical waveguide and a groove adjacent to the third optical waveguide in the second dielectric layer. The groove extends from a top surface of the second dielectric layer and into the second dielectric layer. The second optical waveguide is positioned in the groove in the second chip.

According to various embodiments, a method of forming a structure is provided. The method includes forming a first chip having a first surface and including a first optical component and an optical waveguide protrusion adjacent to the first optical component, the optical waveguide protrusion extending above the first surface of the first chip, forming a second chip having a second surface and including a second optical component and a groove adjacent to the second optical component, the groove extending from the second surface of the second chip and into a portion of the second chip, and positioning the optical waveguide protrusion in the groove in the second chip. The method includes bonding the first surface of the first chip to the second surface of the second chip.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following:

FIGS. 1A, 2A, 3A, 4A, 5A, 6A illustrate cross-sectional views of a first chip or wafer and a second chip or wafer at a fabrication stage of a method for forming a structure in accordance with various embodiments of the invention, and FIGS. 1B, 2B, 3B, 4B, 5B, 6B illustrate cross-sectional view of a structure after stacking and/or bonding the first chip and the second chip of FIGS. 1A, 2A, 3A, 4A, 5A, 6A together, respectively, in accordance with various embodiments of the invention;

FIG. 1C illustrates an exemplary top view of the structure of FIG. 1B, in accordance with various embodiments of the invention;

FIG. 6C illustrates an exemplary top view of the structure of FIG. 6B, in accordance with various embodiments of the invention;

FIGS. 7A, 8A, 9A illustrate cross-sectional views of another exemplary embodiment of the first chip or wafer and the second chip or wafer prior to stacking and/or bonding, and FIGS. 7B, 8B, 9B illustrate cross-sectional views of another exemplary embodiment of a structure after stacking and/or bonding the first chip and the second chip of FIGS. 7A, 8A, 9A together, respectively, in accordance with various embodiments of the invention;

FIG. 10 illustrate cross-sectional view of yet another exemplary embodiment of a structure, in accordance with various embodiments of the invention;

FIG. 11 illustrates a structure having multiple chips bonded together, in accordance with various embodiments of the invention;

FIGS. 12A, 13A, 14A illustrate cross-sectional views of another exemplary embodiment of the first chip or wafer and the second chip or wafer prior to stacking and/or bonding, and FIGS. 12B, 13B, 14B illustrate cross-sectional views of another exemplary embodiment of a structure after stacking and/or bonding the first chip and the second chip of FIGS. 12A, 13A, 14A together, respectively, in accordance with various embodiments of the invention; and

FIGS. 15A-15B illustrate another embodiment of a method for forming a structure in accordance with various embodiments of the invention.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the embodiments. Other embodiments may be utilized and structural, logical, and electrical changes may be made without departing from the scope of the invention. The various embodiments are not necessarily mutually exclusive, as some embodiments can be combined with one or more other embodiments to form new embodiments.

Aspects of the present invention and certain features, advantages, and details thereof, are explained more fully below with reference to the non-limiting examples illustrated in the accompanying drawings. Descriptions of well-known materials, fabrication tools, processing techniques, etc., are omitted so as not to unnecessarily obscure the invention in detail. It should be understood, however, that the detailed description and the specific examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

Embodiments generally relate to devices and methods for forming devices. The devices may be, for example, semiconductor devices. For example, the semiconductor devices may be integrated circuits (ICs). Embodiments may be employed to form a three-dimensional (3D) device stack structure, which may be, or include, multiple devices stacked together. The devices of the stack may be the same type of device or a combination of different types of devices, for example, electronic and photonic devices stacked together. The device stack, for example, may be employed for data transfer.

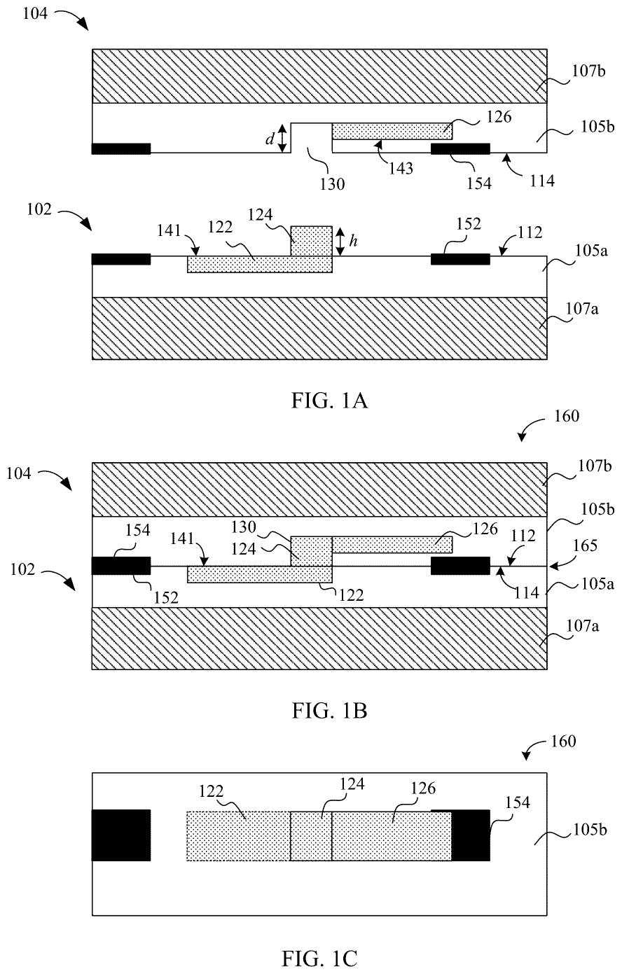

FIG. 1A illustrates a cross-sectional view of chip 102 and chip 104 at a fabrication stage of a method for forming a structure in accordance with various embodiments of the invention. The fabrication stage may be prior to stacking and bonding the chip 102 and the chip 104. The chip 104 is depicted in a flipped orientation. The chips 102 and 104, for example, may each be part of two different wafers. Alternatively, the chips 102 and 104 may each be individual chips after wafer singulation. In yet other embodiments, one of the chips, for example chip 102, may be part of a wafer, while the other chip, for example chip 104, may be an individual chip after wafer singulation, and the chips 102 and 104 may be subsequently bonded together, for example, in a chip-to-wafer bonding process. The chip 102 may have a first surface 112. The first surface 112, for example, may be a top surface of the chip 102. The chip 102 may include an optical waveguide protrusion 124 extending above the first surface 112 of the chip 102. The optical waveguide protrusion 124 may extend above the first surface 112 by a thickness or height h. For example, the optical waveguide protrusion 124 may have a height h of about 50 nm to about 5000 nm from the first surface 112 of chip 102. The optical waveguide protrusion 124 may be configured to transfer light in a first direction with respect to the first surface 112 of the chip 102. The first direction may be away from the chip 102 or towards the chip 102. For example, the first direction may be a vertical direction with respect to the first surface 112 of the chip 102.

In one embodiment, the chip 102 may include an optical component 122 configured to transfer optical signals to or from the optical waveguide protrusion 124. The optical component 122 may be positioned adjacent to the optical waveguide protrusion 124. The optical component 122 may be configured to transfer light in a second direction with respect to the first surface 112 of the chip 102. The second direction may be different from the first direction. In one embodiment, the second direction may be a lateral direction with respect to the first surface 112 of the chip 102. In one embodiment, the optical component 122 may be an optical waveguide. For example, the optical component 122 may be a first optical waveguide and the optical waveguide protrusion 124 may be a second optical waveguide of the chip 102. The first optical waveguide, for example, may be a rib waveguide. In one embodiment, the first optical waveguide and the second optical waveguide may be formed of the same material.

In one embodiment, the optical waveguide protrusion 124 may be disposed on a top surface 141 of the optical component 122, as illustrated in FIG. 1A. In other words, the optical waveguide protrusion 124 may be vertically stacked on the optical component 122. In the case that the optical component 122 is an optical waveguide, the optical waveguide protrusion 124 may overlap a portion of the top surface 141 of the optical component 122 and directly contact the optical component 122.

In one embodiment, the chip 102 may include a dielectric layer 105a. In some embodiments, the dielectric layer 105a may be arranged over a substrate 107a, such as a semiconductor substrate. The semiconductor substrate, for example, may be a silicon substrate. In other embodiments, the substrate 107a need not be provided. The dielectric layer 105a may be formed of a dielectric material having an index of refraction which is lower than the material of the optical component 122 and/or the optical waveguide protrusion 124. For example, the dielectric layer 105a may be formed of a dielectric material such as silicon dioxide. The layer of dielectric material may be planarized to provide the dielectric layer 105a with a substantially flat or planar top surface. The top surface of the dielectric layer 105a, in one embodiment, may be the first surface 112 of the chip 102. The dielectric layer 105a may surround side surfaces and a bottom surface the optical component 122. In one embodiment, the top surface of the dielectric layer 105a may be substantially coplanar with the top surface 141 of the optical component 122. In some embodiments, the dielectric layer 105a may include metal wiring arranged therein.

The optical waveguide protrusion 124 may be formed of a homogeneous material (e.g., uniform composition throughout). In one embodiment, the optical waveguide protrusion 124 may be formed of a semiconductor material such as silicon. In another embodiment, the optical waveguide protrusion 124 may be formed of a dielectric material such as silicon nitride. The optical waveguide protrusion 124 may be formed by depositing (e.g., chemical vapor deposition) and patterning its constituent material (e.g., silicon or silicon nitride). For example, the optical waveguide protrusion 124 may be formed by patterning its constituent material using laser ablation. Laser ablation may be used for precision patterning (e.g., material removal) of the optical waveguide protrusion 124 in the nanometer scale. For example, a laser beam, such as from a laser system (e.g., excimer laser), is focused onto the constituent material to cause portions of the material to heat up rapidly. The laser beam may be used to vaporize or blast off a layer of material from the surface irradiated by the laser beam. The depth and precision of material removal may be controlled, for example, by adjusting the laser's power, wavelength, pulse duration, repetition rate, and the focusing optics. For example, the laser beam may have spot size, height×width×length of about 2 nm×20 nm×20 nm. In other embodiments, the optical waveguide protrusion 124 may be formed by patterning its constituent material with lithography and etching (e.g., chemical etching) processes. In some embodiments, the optical waveguide protrusion 124 may be patterned by lithography and etching processes and subsequently patterned by laser ablation. In one embodiment, the optical waveguide protrusion 124 may be formed on the top surface 141 of the optical component 122 and extends to the height, h above the first surface 112 of the chip 102.

Now referring to chip 104 which is depicted as inverted in FIGS. 1A and 1B, the chip 104 may have a second surface 114. The chip 104 may include a groove or recess 130 extending below the second surface 114 of the chip 104. In other words, the groove 130 may extend from the second surface 114 of the chip 104 and into a portion of the chip 104. The groove 130 may extend from the second surface 114 and partially into the chip 104, with a depth, d from the second surface 114 of the chip 104. The depth, d may match the height, h of the optical waveguide protrusion 124. In some cases, the height, h of the optical waveguide protrusion 124 may be similar to the depth, d of the groove 130 with the height, h of the optical waveguide protrusion 124 having an overetch margin of about 2 nm to about 10 nm to facilitate interlocking with the groove 130. The groove 130 may be configured to receive the optical waveguide protrusion 124 when the chips 102 and 104 are stacked and/or bonded together with the first surface 112 of the chip 102 facing the second surface 114 of the chip 104. The groove 130 may correspond to a shape of the optical waveguide protrusion 124. In one embodiment, the groove 130 may be configured to match a 3D shape of the optical waveguide protrusion 124. For example, in the case the optical waveguide protrusion 124 has a shape such as cube, cuboid, cylinder, hollow cylinder, rectangular pyramid, or triangular prism, the groove 130 may have a corresponding shape of a cube, cuboid, cylinder, hollow cylinder, rectangular pyramid, or triangular prism in the chip 104.

In one embodiment, the chip 104 may further include an optical component 126. The optical component 126 may be positioned adjacent to the groove 130. In one embodiment, the optical component 126 may be an optical waveguide (e.g., third optical waveguide). The third optical waveguide, for example, may be a rib waveguide. In one embodiment, the optical component 126 may be formed of the same material as the optical component 122 and the optical waveguide protrusion 124 of the chip 102. Providing the optical component 122, the optical waveguide protrusion 124 and the optical component 126 formed of the same material may advantageously facilitate high optical coupling efficiency between the optical component 122 of chip 102 and the optical component 126 of chip 104 when the chips are stacked to form a device stack structure. In one embodiment, the optical component 126 may abut the groove 130. For example, the groove 130 may expose a side surface of the optical component 126, as illustrated in FIG. 1A.

The chip 104 may include a dielectric layer 105b. In some embodiments, the dielectric layer 105b may be arranged over a substrate 107b, such as a semiconductor substrate. The semiconductor substrate, for example, may be a silicon substrate. In other embodiments, the substrate 107b need not be provided. The dielectric layer 105b may be formed of a dielectric material having an index of refraction which is lower than the material of the optical component 126 and/or the optical waveguide protrusion 124. For example, the dielectric layer 105b may be formed of a dielectric material such as silicon dioxide. The layer of dielectric material may be planarized to provide the dielectric layer 105b with a substantially flat or planar top surface. The top surface of the dielectric layer 105b may be the second surface 114 of the chip 104. In one embodiment, the optical component 126 may be embedded in the dielectric layer 105b. As illustrated in FIG. 1A, the dielectric layer 105b may cover a top surface 143 of the optical component 126. In some embodiments, the dielectric layer 105b may include metal wiring arranged therein. In one embodiment, the dielectric layer 105b may be a continuous layer formed over the substrate 107b. In other embodiments, the dielectric layer 105b may be formed in trench opening(s) in the substrate 107b and may have a substantially planar top surface with the substrate 107b (not shown). For example, the optical component 126 may be embedded in the dielectric layer 105b which is formed in a trench opening in the substrate 107b.

In one embodiment, the groove 130 may be formed or dimensioned to fit the optical waveguide protrusion 124. For example, the groove 130 may precisely fit the optical waveguide protrusion 124. In one embodiment, the groove 130 may be formed in the dielectric layer 105b by using laser ablation. The laser ablation process may be similar to that used for forming the optical waveguide protrusion 124. In other embodiments, the groove 130 may be formed in the dielectric layer 105b by lithography and etching (e.g., chemical etching) processes. In other embodiments, the groove 130 may be patterned by lithography and etching processes and subsequently using laser ablation. The groove 130 may extend from the top surface of the dielectric layer 105b to a depth d, which matches the height h of the optical waveguide protrusion 124.

The chip 102 may include bond pads 152, while the chip 104 may include corresponding bond pads 154 for bonding to the bond pads 152 of chip 102. The bond pads 152 and 154 may be arranged at a predetermined distance from the optical component 122, optical waveguide protrusion 124 and optical component 126. The bond pads 152 and 154 may be formed, for example, of a metallic material such as copper.

In some embodiments, the chips 102 and 104 may each include electronic and/or optical devices. The electronic devices may include active and/or passive components, for example, formed using CMOS processes. For example, the chip 102 may include one or more electronic components arranged on or over the substrate 107a. Similarly, the chip 104 may include one or more electronic components arranged on or over the substrate 107b. The chip 102 and/or chip 104 may further include optical devices such as, but not limited to, a laser, a modulator, a multiplexer, etc.

The chips 102 and 104 may be joined together in a face-to-face bonding. In one embodiment, the chip 104 may be stacked over the chip 102. In another embodiment, the chip 102 may be stacked over the chip 104. Referring to FIG. 1B, the chips 102 and 104 may be stacked to form a structure 160 with the second surface 114 of chip 104 being adjacent to the first surface 112 of the chip 102. The structure 160 may be a device stack. The chips 102 and 104 may be brought together with the first surface 112 of the chip 102 and the second surface 114 of the chip 104 facing each other. For example, one of the chips 102 and 104 may be placed on a stationary plate, while the other chip is aligned and moved towards it to form the structure 160. The chip 102 and/or chip 104 may be moved to align the optical waveguide protrusion 124 to the groove 130. The optical waveguide protrusion 124 may be inserted into the groove 130 in the chip 104 so as to interlock with the groove 130. The optical waveguide protrusion 124 may completely fill a space in the groove 130. In some embodiments, the optical waveguide protrusion 124 may be used as a dedicated alignment mark in addition to serving as an optical waveguide. The chips 102 and 104, for example, may be bonded together via wafer bonding processes. In other embodiments, the chips 102 and 104 may be bonded together via chip-to-wafer or chip-to-chip bonding processes. The first surface 112 of chip 102 may be bonded to the second surface 114 of chip 104 at a bonding interface 165. The second surface 114 of the chip 104 may directly contact the first surface 112 of the chip 102 at the bonding interface 165. The chips 102 and 104 may be bonded together by dielectric bonding or hybrid bonding. For example, in the dielectric bonding process, a low temperature anneal may be performed at a sufficient temperature and for a sufficient duration to establish a face-to-face bond between contacting surfaces of the dielectric layer 105a of the chip 102 and the dielectric layer 105b of the chip 104. In the hybrid bonding process, metal-metal bonds (e.g., Cu—Cu bonds) may be formed between the bond pads 152 of chip 102 and the corresponding bond pads 154 of chip 104, and dielectric-dielectric bonds (e.g., oxide-oxide bonds) may be formed between the dielectric layer 105a of chip 102 and the dielectric layer 105b of chip 104. For example, standard thermocompressive bonding tools and techniques may be used.

Accordingly, the optical waveguide protrusion 124 of chip 102 is positioned in the groove 130 in the chip 104 of the device stack. The dielectric layer 105b of the chip 104 may surround the optical waveguide protrusion 124 when the optical waveguide protrusion 124 is positioned in the groove 130. The optical component 122, the optical waveguide protrusion 124 and the optical component 126 may be optically coupled to each other. The optical waveguide protrusion 124 may be configured to couple and transmit optical signals from the optical component 122 of the chip 102 to the optical component 126 of the chip 104, or from the optical component 126 of the chip 104 to the optical component 122 of the chip 102. In one embodiment, the optical component 126 is arranged laterally adjacent to the optical waveguide protrusion 124 such that the optical waveguide protrusion 124 may laterally couple optical signals to a side surface of the optical component 126. In one embodiment, the optical waveguide protrusion 124 may abut a side surface of the optical component 126, as illustrated in FIG. 1B.

In the case that the optical component 126 is an optical waveguide, in one embodiment, the optical waveguide protrusion 124 may be bonded to the optical component 126 and to the dielectric layer 105b of the chip 104 in a second bonding process. In one embodiment, the second bonding process may employ laser ablation. For example, laser ablation may be used to melt and fuse the optical waveguide protrusion 124 and the optical component 126 together at the abutting side surfaces, and the optical waveguide protrusion 124 and the dielectric layer 105b of the chip 104 at the abutting surfaces. Bonding the optical waveguide protrusion 124 to the optical component 126 may minimize optical losses.

FIG. 1C illustrates an exemplary top view of the structure 160 after bonding the chips 102 and 104 together, in accordance with various embodiments of the invention. The optical waveguide protrusion 124 directly contacts the optical component 126 in the chip 104 and overlaps and directly contacts the optical component 122 in the chip 102. Accordingly, the optical waveguide protrusion 124 may transfer optical signals from chip 102 to chip 104 or from chip 104 to chip with minimal or reduced optical loss.

Accordingly, optical signals may be coupled efficiently between optical waveguides in different chips or wafers of the device stack structure through the optical waveguide protrusion. The optical waveguide protrusion according to various embodiments may advantageously facilitate optical transmission between chips, or wafers, or chip-to-wafer with reduced loss of optical signals. Further, the optical waveguide protrusion may facilitate forming a 3D device stack structure using different chips/wafers.

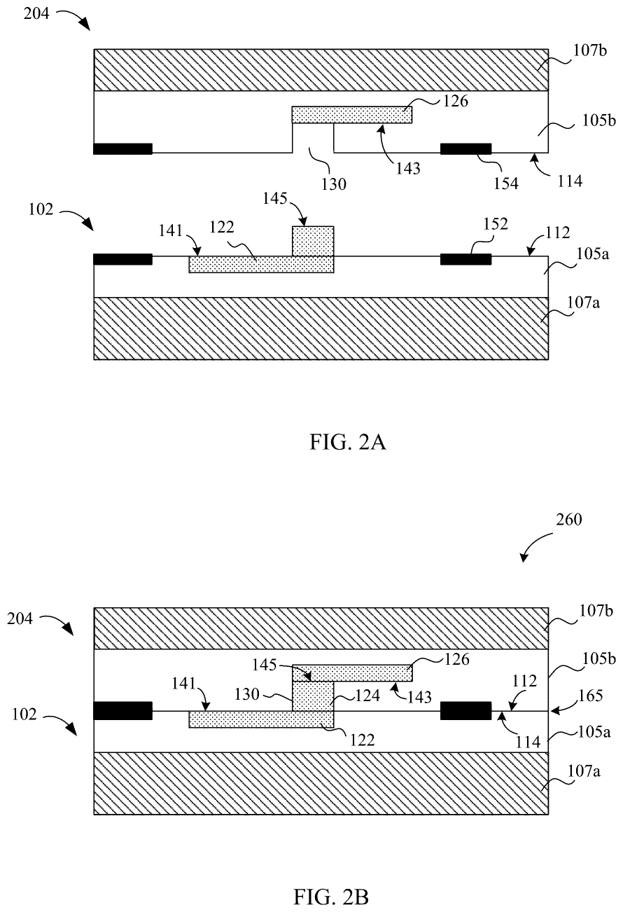

FIGS. 2A-2B illustrate another embodiment of a method for forming a structure in accordance with various embodiments of the invention. In FIGS. 2A-2B, like numerals refer to like elements of FIGS. 1A-1B. The method is similar to those described in FIGS. 1A-1B, but in this case, for chip 204, which is similarly depicted as inverted in FIGS. 2A and 2B, the groove 130 is positioned over the optical component 126 in the chip 204. The groove 130 may expose a portion of the top surface 143 of the optical component 126. FIG. 2B illustrates a cross-sectional view of a structure 260 after stacking and/or bonding the chips 102 and 204 together, in accordance with various embodiments of the invention.

The chips 102 and 204 may be brought together with the first surface 112 of the chip 102 and the second surface 114 of the chip 204 facing each other. The chip 102 and/or chip 204 may be moved to align the optical waveguide protrusion 124 to the groove 130. The optical waveguide protrusion 124 may be inserted into the groove 130 in the chip 104 so as to interlock with the groove 130. The chips 102 and 204 may be bonded in the same manner as chips 102 and 104 as described with respect to FIG. 1B. In one embodiment, the optical component 126 is arranged over the optical waveguide protrusion 124 in the structure 160 such that the optical waveguide protrusion 124 may vertically couple optical signals to the top surface 143 of the optical component 126. The optical component 126 overlaps the optical waveguide protrusion 124 in the structure 160. In one embodiment, a top surface 145 of the optical waveguide protrusion 124 abuts a portion of the top surface 143 of the optical component 126 as shown in FIG. 2B. Similar to chips 102 and 104 in FIG. 1B, in the case that the optical component 126 is an optical waveguide, the optical waveguide protrusion 124 of chip 102 may be bonded to the optical component 126 and to the dielectric layer 105b of the chip 204 in a second bonding process. For example, laser ablation may be used to melt and fuse the optical waveguide protrusion 124 and the optical component 126 together at the abutting top surfaces, and the optical waveguide protrusion 124 and the dielectric layer 105b of the chip 204 at the abutting surfaces.

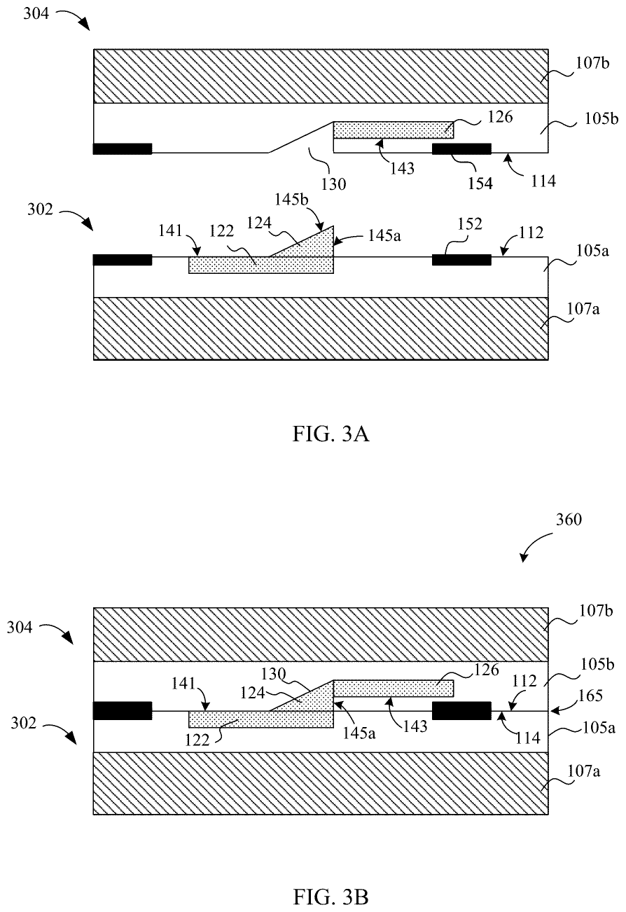

FIGS. 3A-3B illustrate cross-sectional views of chips 302 and 304, in which like numerals refer to like elements of the previous figures. The chip 304 is depicted as inverted in FIGS. 3A and 3B. In one embodiment, the optical waveguide protrusion 124 of chip 302 has a right triangle cross-section and the groove 130 of chip 304 has a corresponding right triangle cross-section. For example, the optical waveguide protrusion 124 and the groove 130 may have the shape of a right angle prism. Referring to FIG. 3A, the optical waveguide protrusion 124 may include a side surface 145a which extends at a right angle with respect to the first surface 112 of the chip 302, and an adjoining side surface 145b which is slanted with respect to the first surface 112 of the chip 302. The side surface 145b may adjoin the side surface 145a to form a corner of the optical waveguide protrusion 124 having an acute angle. FIG. 3B illustrates a cross-sectional view of a structure 360 after stacking and/or bonding the chips 302 and 304 together, in accordance with various embodiments of the invention. The chip 302 and/or chip 304 may be moved to align the optical waveguide protrusion 124 to the groove 130. The optical waveguide protrusion 124 may be inserted into the groove 130 in the chip 304 so as to interlock with the groove 130. The optical waveguide protrusion 124 may fill a space in the groove 130. The top surface of the dielectric layer 105a may directly contact the top surface of the dielectric layer 105b. The chips 302 and 304 may be bonded in the same manner as chips 102 and 104 as described with respect to FIG. 1B.

In one embodiment, the side surface 145a of the optical waveguide protrusion 124 may abut a side surface of the optical component 126 as shown in FIG. 3B. The dielectric layer 105b of the chip 304 may surround the optical waveguide protrusion 124 and abut the side surface 145b and a portion of the side surface 145a of the optical waveguide protrusion 124. Similar to chips 102 and 104 in FIG. 1B, in the case that the optical component 126 is an optical waveguide, the optical waveguide protrusion 124 of chip 302 may be bonded to the optical component 126 and to the dielectric layer 105b of the chip 304 in a second bonding process. For example, laser ablation may be used to melt and fuse the optical waveguide protrusion 124 and the optical component 126 together at the abutting side surfaces, and the optical waveguide protrusion 124 and the dielectric layer 105b of the chip 304 at the abutting surfaces.

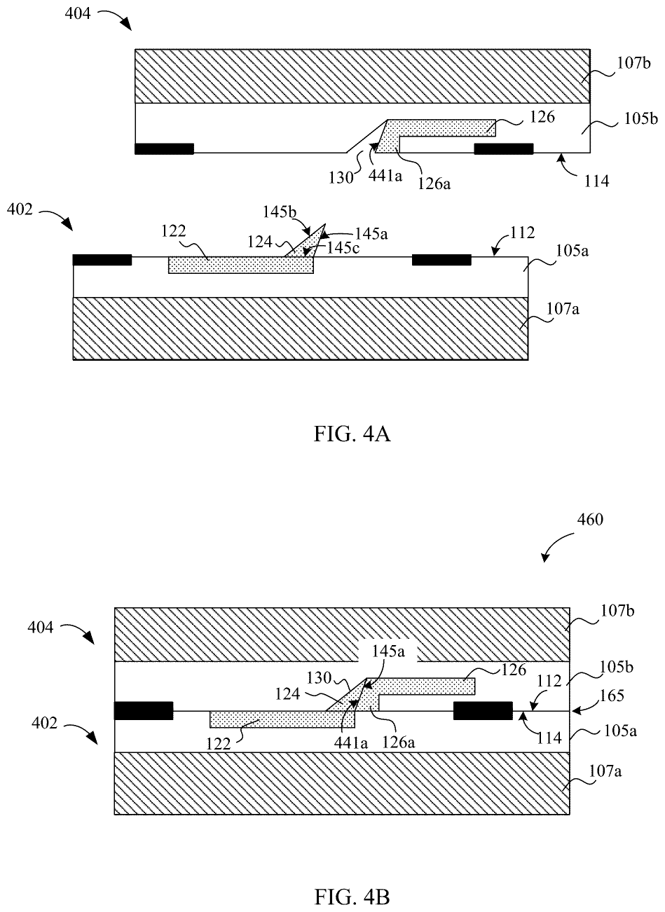

FIGS. 4A-4B illustrate cross-sectional views of chips 402 and 404, in which like numerals refer to like elements of the previous figures. The chip 404 is depicted as inverted in FIGS. 4A and 4B. In one embodiment, the optical waveguide protrusion 124 of chip 402 has a side surface 145a which may be slanted at a first angle with respect to the first surface 112 of chip 402 and an adjoining side surface 145b which may be slanted at a second angle with respect to the first surface 112 of the chip 402, as illustrated in FIG. 4A. The first angle and the second angle may be acute angles. In some embodiments, the second angle may be different from the first angle. In other embodiments, the first angle and the second angle may be the same. The side surface 145a may adjoin the side surface 145b to form a first corner of the optical waveguide protrusion 124 having an acute angle. The side surface 145a may adjoin a bottom surface 145c of the optical waveguide protrusion 124 to form a second corner of the optical waveguide protrusion 124 having an obtuse angle. The side surface 145b may adjoin the bottom surface 145c to form a third corner of the optical waveguide protrusion 124 having an acute angle. For example, the optical waveguide protrusion 124 may be formed by depositing one or more layers of its constituent material (e.g., silicon or silicon nitride) and patterning using laser ablation to form the side surfaces 145a, 145b and the first corner having the acute angle. The chip 404 may have the groove 130 with a corner having the corresponding acute angle to the first corner of the optical waveguide protrusion 124. In one embodiment, the optical component 126 may be an optical waveguide (e.g., third optical waveguide) and may include an extension portion 126a. For example, the extension portion 126a of the third optical waveguide may extend laterally from the side surface of the third optical waveguide and vertically to the second surface 114 of the chip 404. The extension portion 126a of the third optical waveguide may have a side surface 441a which may be slanted at a third angle with respect to the second surface 114 of chip 404. The third angle of the side surface 441a may correspond to the first angle of the side surface 145a of the optical waveguide protrusion 124 and may be the same. For example, groove 130 and extension portion 126a of the third optical waveguide may be formed by forming a cavity in the dielectric layer 105b of chip 404, the cavity may abut and expose a side surface of the third optical waveguide, filling the cavity with constituent material of the extension portion 126a of the optical waveguide, performing a planarization process to form a substantially planar top surface of the dielectric layer 105b and the material of the extension portion 126a, and subsequently patterning the dielectric layer 105b and the material of the extension portion 126a using laser ablation to form groove 130 and the extension portion 126a with the side surface 441a. The groove 130 may expose the side surface 441a of the extension portion 126a of the third optical waveguide, as illustrated in FIG. 4A.

FIG. 4B illustrates a cross-sectional view of a structure 460 after stacking and/or bonding the chips 402 and 404 together, in accordance with various embodiments of the invention. The chip 402 and/or chip 404 may be moved to align the optical waveguide protrusion 124 to the groove 130. For example, the alignment may include vertical and horizontal movements of the chip 402 and/or chip 404 so as to insert the optical waveguide protrusion 124 into the groove 130 in the chip 404. The optical waveguide protrusion 124 may be inserted into the groove 130 in the chip 404 so as to interlock with the groove 130. The side surface 145a of the optical waveguide protrusion 124 may abut the side surface 441a of the extension portion 126a of the third optical waveguide as shown in FIG. 4B. The extension portion 126a may improve optical coupling between the optical waveguide protrusion 124 and the third optical waveguide. The chips 402 and 404 may be bonded in the same manner as chips 102 and 104 as described with respect to FIG. 1B. The optical waveguide protrusion 124 of chip 402 may be bonded to the extension portion 126a of the third optical waveguide and to the dielectric layer 105b of the chip 404 in a second bonding process similar to that described with respect to chips 102 and 104 in FIG. 1B.

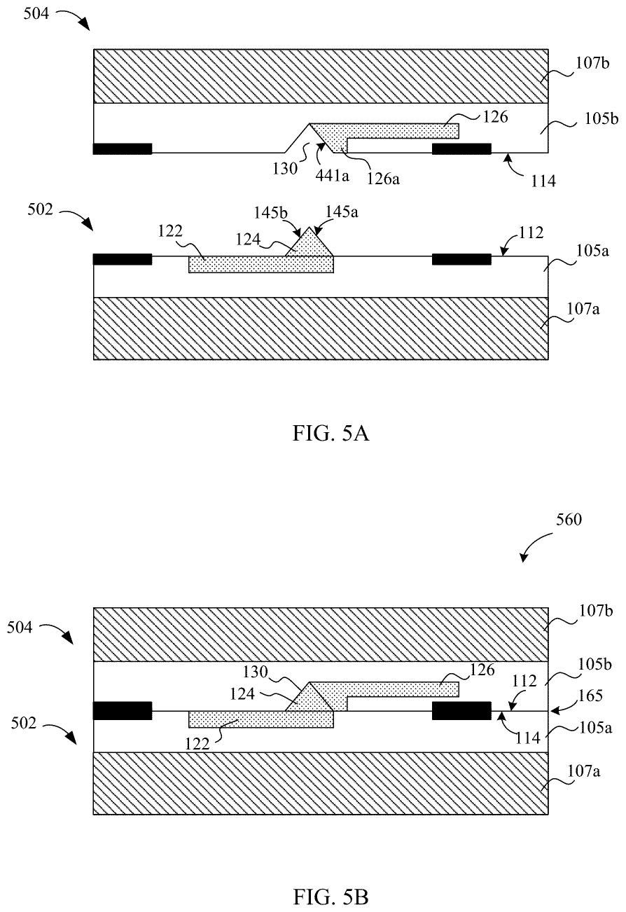

FIGS. 5A-5B illustrate cross-sectional views of chips 502 and 504, in which like numerals refer to like elements of the previous figures. The chip 504 is depicted as inverted in FIGS. 5A and 5B. In one embodiment, the optical waveguide protrusion 124 of chip 502 has a side surface 145a which may be slanted at a first angle with respect to the first surface 112 of the chip 502, and an adjoining side surface 145b which may be slanted at a second angle with respect to the first surface 112 of the chip 502, as illustrated in FIG. 5A. The first angle may be an obtuse angle while the second angle may be an acute angle. The side surface 145a may adjoin the side surface 145b to form a corner of the optical waveguide protrusion 124 having an obtuse angle of the optical waveguide protrusion 124 above the first surface 112 of the chip 502. For example, the optical waveguide protrusion 124 may be formed by depositing one or more layers of its constituent material (e.g., silicon or silicon nitride) and patterning using laser ablation to form the side surfaces 145a, 145b and the corner having the obtuse angle. The chip 504 may have the groove 130 with a corner having the corresponding obtuse angle. For example, the optical waveguide protrusion 124 may have the shape of a triangular prism. In one embodiment, the optical component 126 may be an optical waveguide (e.g., third optical waveguide) and may include an extension portion 126a. For example, the extension portion 126a of the third optical waveguide may extend laterally from the side surface of the third optical waveguide and vertically to the second surface 114 of the chip 504. The extension portion 126a of the third optical waveguide may have a side surface 441a which may be slanted at a third angle with respect to the second surface 114 of chip 504. The third angle of the side surface 441a may correspond to the first angle of the side surface 145a of the optical waveguide protrusion 124 and may be the same. The groove 130 and extension portion 126a of the third optical waveguide of chip 504 may be formed in a similar manner as that described with respect to the groove 130 and extension portion 126a of the third optical waveguide of chip 404 in FIG. 4A. The groove 130 may expose the side surface 441a of the extension portion 126a of the third optical waveguide.

FIG. 5B illustrates a cross-sectional view of a structure 560 after stacking and/or bonding the chips 502 and 504 together, in accordance with various embodiments of the invention. The chip 502 and/or chip 504 may be moved to align the optical waveguide protrusion 124 to the groove 130. The optical waveguide protrusion 124 may be positioned in the groove 130 in the chip 504 so as to interlock with the groove 130. The side surface 145a of the second optical waveguide 124 may abut the side surface 441a of the extension portion 126a of the third optical waveguide. The extension portion 126a may improve optical coupling between the optical waveguide protrusion 124 and the third optical waveguide. The chips 502 and 504 may be bonded in the same manner as chips 102 and 104 as described with respect to FIG. 1B. The optical waveguide protrusion 124 of chip 502 may be bonded to the extension portion 126a of the third optical waveguide and to the dielectric layer 105b of the chip 504 in a second bonding process similar to that described with respect to chips 102 and 104 in FIG. 1B.

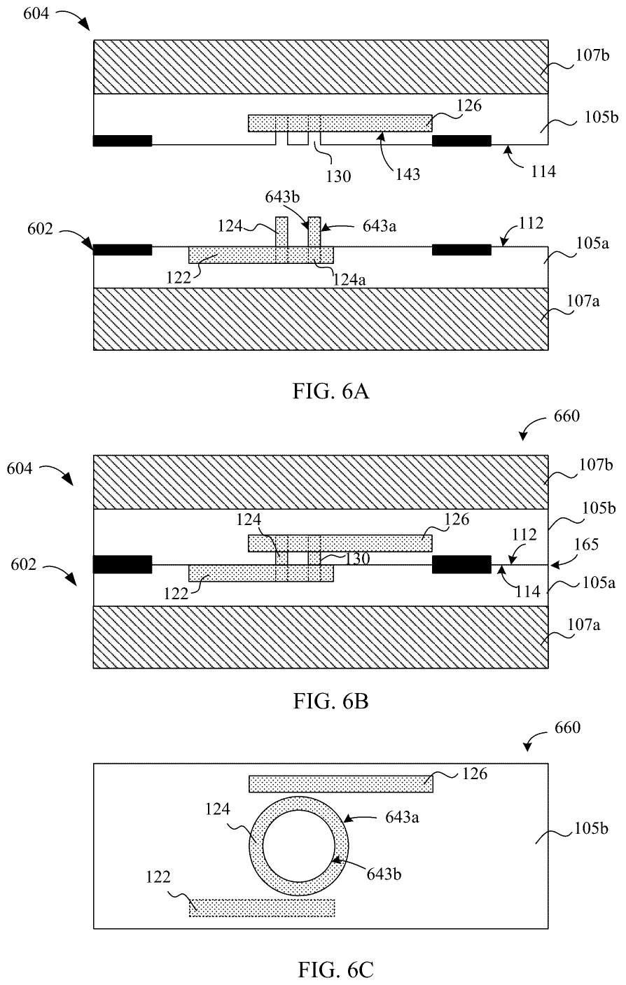

FIGS. 6A-6B illustrate side views of chips 602 and 604, in which like numerals refer to like elements of the previous figures. The chip 604 is depicted as inverted in FIGS. 6A and 6B. In one embodiment, the optical waveguide protrusion 124, which extends above the first surface 112 of the chip 602, may be an upper portion of a second optical waveguide, and the second optical waveguide may further include a lower portion 124a extending below the first surface 112 of the chip 602 and into a portion of the chip 602. The second optical waveguide may be an annular waveguide having concentric inner and outer ring-shaped edges 643b and 643a, as illustrated in FIG. 6A and FIG. 6C. The second optical waveguide may have a closed loop configuration. The second optical waveguide forms a ring resonator. For example, the ring resonator may be configured to transfer and/or filter light of a predetermined frequency or range of frequencies. The groove 130 has a corresponding ring-shaped configuration which matches the ring-shaped configuration of the optical waveguide protrusion 124 (e.g., the upper portion of the second optical waveguide). In one embodiment, the optical component 122 of chip 602 may be a first optical waveguide, while the optical component 126 of chip 604 may be a third optical waveguide. The lower portion 124a of the second optical waveguide may be laterally spaced from the first optical waveguide in the chip 602 (shown as dotted lines in FIGS. 6A and 6B). The lower portion 124a of the second optical waveguide may be separated from the first optical waveguide by dielectric material of the dielectric layer 105a of chip 602 (not shown in FIG. 6A). The groove 130 may be separated from the third optical waveguide by dielectric material of the dielectric layer 105b of chip 604 (not shown in FIG. 6A).

FIG. 6B illustrates a cross-sectional view of a structure 660 after stacking and/or bonding the chips 602 and 604 together, in accordance with various embodiments of the invention. The chip 602 and/or chip 604 may be moved to align the optical waveguide protrusion 124, which in this case has an annular configuration, to the groove 130. The optical waveguide protrusion 124 may be inserted into the groove 130 in the chip 604 so as to interlock with the groove 130. The chips 602 and 604 may be bonded in the same manner as chips 102 and 104 as described with respect to FIG. 1B. The optical waveguide protrusion 124 of chip 602 (e.g., the upper portion of the second optical waveguide may be bonded to the dielectric layer 105b of the chip 604 in a second bonding process. For example, laser ablation may be used to melt and fuse the optical waveguide protrusion 124 and the dielectric layer 105b of the chip 604 at surfaces where the optical waveguide protrusion 124 contacts the dielectric layer 105b.

FIG. 6C illustrates an exemplary top view of the structure 660 after stacking and/or bonding the chips 602 and 604 together, in accordance with various embodiments of the invention. As shown, the optical waveguide protrusion 124 (e.g., upper portion of the second optical waveguide) may be spaced apart from the optical component 122 (e.g., the first optical waveguide) and the optical component 126 (e.g., the third optical waveguide). For example, the second optical waveguide may be laterally spaced from the first optical waveguide and from the third optical waveguide. In other words, the second optical waveguide does not physically contact the first optical waveguide and the third optical waveguide. The first optical waveguide, the second optical waveguide which forms the ring resonator and the third optical waveguide may be optically coupled to each other. As described, the ring resonator may be configured to transfer light of a predetermined frequency or range of frequencies. One of the first optical waveguide and the third optical waveguide may be an input bus, while the other may be an output bus.

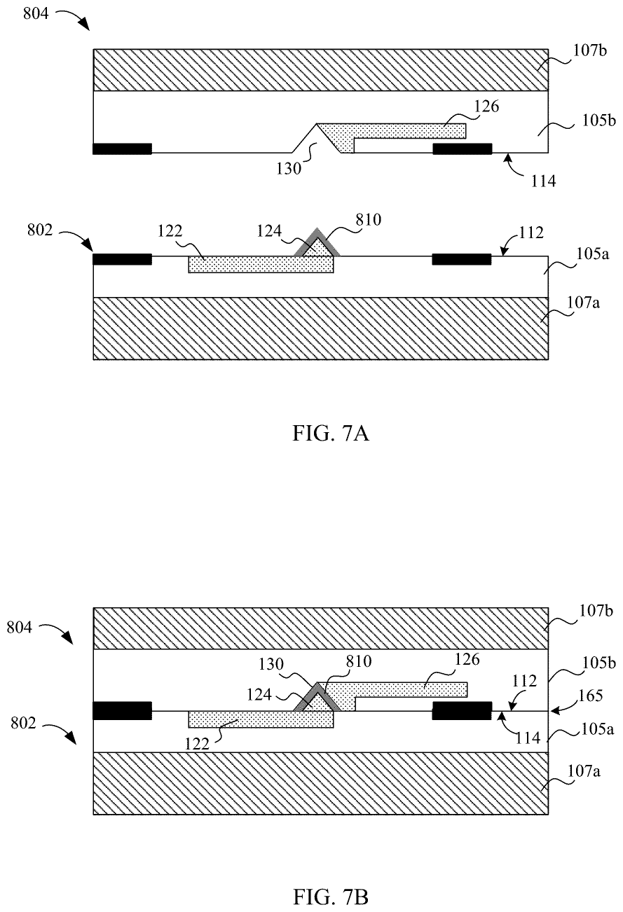

In other embodiments, the structure may include a sealing material between the optical waveguide protrusion 124 and the groove 130. In one embodiment, the sealing material may be formed on the optical waveguide protrusion 124 prior to bonding the chips together. FIGS. 7A-7B illustrate cross-sectional views of chips 802 and 804, in which like numerals refer to like elements of the previous figures. The chip 804 is depicted as inverted in FIGS. 7A and 7B. Referring to FIG. 7A, chip 802 may include the optical waveguide protrusion 124 extending above the first surface 112 of chip 802, and a sealing material 810 lining a surface of the optical waveguide protrusion 124. The sealing material 810, for example, may have a liquid composition and may be cured to harden with light or temperature. In some embodiments, the sealing material 810 may be applied on a die-to-die basis. In other embodiments, the sealing material 810 may be coated or filled in the groove 130 of chip 804, for example, prior to stacking the wafers together. When the wafers are stacked together, the sealing material 810 may fill the imperfections or surface roughness of the optical waveguide protrusion 124 and the groove 130. The sealing material 810 may form a sealant having thickness of about 2 nm to about 100 nm depending on the vertical/lateral roughness of the optical waveguide protrusion 124 and the groove 130. The sealant may fill a gap between the surfaces of the optical waveguide protrusion 124 and the groove 130. In some cases, sufficient overetch of the groove 130 matching the vertical/lateral roughness may be performed so as to allow for interlocking of the optical waveguide protrusion 124 and the groove 130.

Referring to FIG. 7B, the optical waveguide protrusion 124 may be positioned in the groove 130 when the chips 802 and 804 are stacked and/or bonded together. The sealing material 810 may fill imperfections between the opposing surfaces of the optical waveguide protrusion 124 and the optical component 126/extension portion of the third optical waveguide and between the opposing surfaces of the optical waveguide protrusion 124 and the dielectric layer 105b. Accordingly, the sealing material 810 may improve light coupling between the optical waveguide protrusion 124 and the optical component 126. The sealing material 810 may have a lower melting temperature than the material of the optical waveguides, and an index of refraction which is similar to the optical waveguides. The sealing material 810 may facilitate connection between the optical waveguide protrusion 124 and the third optical waveguide. In one embodiment, the sealing material 810 may be a bonding glue.

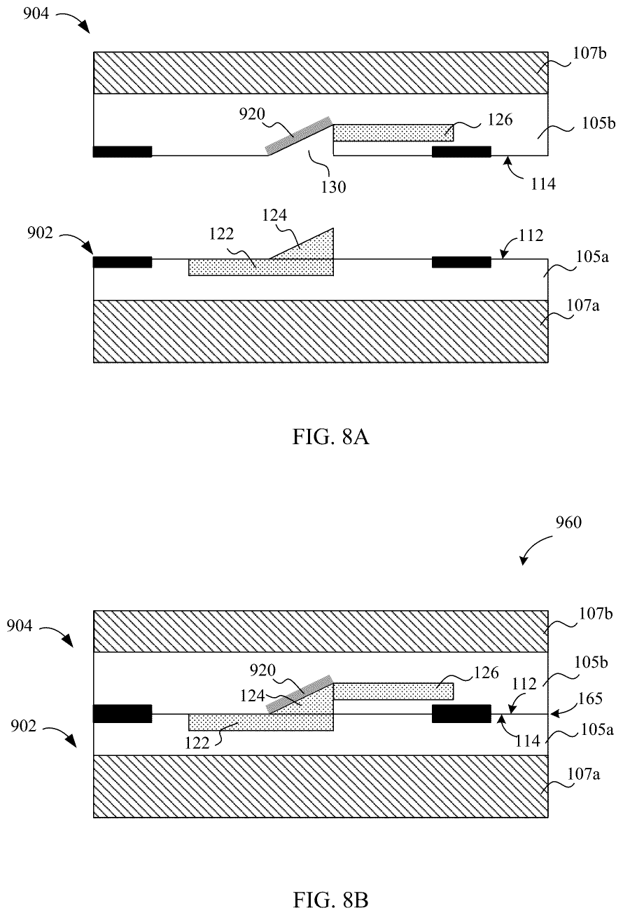

In one embodiment, the structure may include a reflective surface along a side of the groove 130. The optical waveguide protrusion 124 may interface the reflective surface when then chips are stacked and/or bonded together. FIGS. 8A-8B illustrate cross-sectional views of chips 902 and 904, in which like numerals refer to like elements of the previous figures. The chip 904 is depicted as inverted in FIGS. 8A and 8B. Referring to FIG. 8A, a reflective material 920 may be arranged along a side of the groove 130 in chip 904. The groove 130 may expose a reflective surface of the reflective material 920. In one embodiment, the reflective material 920 may be formed, for example, of metal or silicide. In one embodiment, the groove 130 and the reflective surface may be formed by forming a rectangular cavity in the chip 904, filling the cavity with a metallic material, and etching the metallic material using laser ablation (e.g., a subtractive manufacturing process) to form the groove 130, with the remaining metallic material serving as the reflective material 920 along a side of the groove 130. In another embodiment, the reflective material 920 may be formed, for example, by a silicidation process after the groove 130 is formed. As described, in some embodiments, the dielectric layer 105b may be formed in trench opening(s) in the substrate 107b and the dielectric layer 105b may have a substantially planar top surface with the substrate 107b (not shown). The optical component 126 may be embedded in the dielectric layer 105b which is formed in a trench opening in the substrate 107b. In such cases, the groove 130, may be formed to extend from a top surface of the substrate 107b and into a portion of the substrate 107b (not shown), with the groove 130 exposing a side surface of the optical component 126. The reflective material 920 may be then formed along a side of the groove 130 by a silicidation process. Referring to FIG. 8B, the structure 960 may include the optical waveguide protrusion 124 positioned in the groove 130 when the chips 902 and 904 are stacked and/or bonded together. The optical waveguide protrusion 124 positioned in the groove 130 may interface with the reflective surface of the reflective material 920. The reflective surface may be provided to reflect light traveling in the optical waveguide protrusion 124 to the optical component 126, reducing optical loss and improving light coupling between the optical waveguide protrusion 124 and the optical component 126.

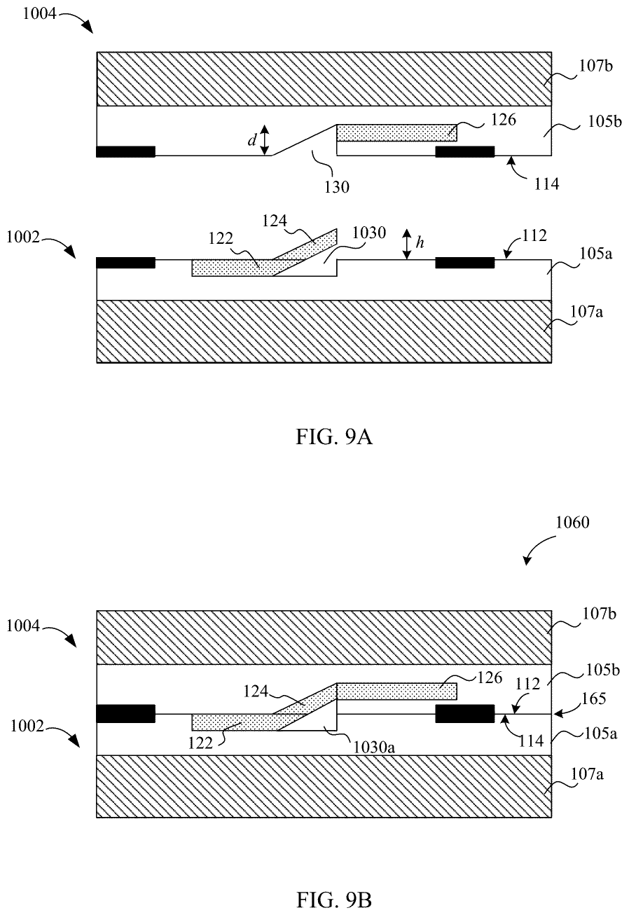

In one embodiment, the structure may include a cavity arranged below the optical waveguide protrusion 124. FIGS. 9A-9B illustrate cross-sectional views of chips 1002 and 1004, in which like numerals refer to like elements of the previous figures. The chip 1004 is depicted as inverted in FIGS. 9A and 9B. Referring to FIG. 9A, chip 1002 may include the optical waveguide protrusion 124 extending above the first surface 112 of the chip 1002. A cavity 1030 may be formed below the optical waveguide protrusion 124. For example, laser ablation may be used to remove a portion of material of the optical waveguide protrusion 124 to form the cavity 1030. In the case that the optical component 122 is an optical waveguide, a portion of material of the optical component 122 may be removed to form the cavity 1030 below the optical waveguide protrusion 124. For example, to remove material beneath the first surface 112 of chip 1002, the laser ablation process may use two or multi-photon absorption (e.g., two or more light sources are focused at a point and scanned to remove material three dimensionally) for the light to penetrate deep and be absorbed within the bulk of the material. In this way, when the light is absorbed, the material can be removed not only from the surface but also beneath. The optical waveguide protrusion 124 may overhang the cavity 1030. Referring to FIG. 9B, the structure 1060 may include the optical waveguide protrusion 124 positioned in the groove 130 when the chips 1002 and 1004 are stacked and/or bonded together. The optical waveguide protrusion 124 may partially fill the groove 130. The cavity 1030 may be enclosed, for example, by the optical component 122, the optical waveguide protrusion 124, and dielectric layers 105a and 105 of the chips 1002 and 1004, respectively, forming an air gap 1030a below the optical waveguide protrusion 124. The air gap 1030a may be provided to minimize reflection and optical losses.

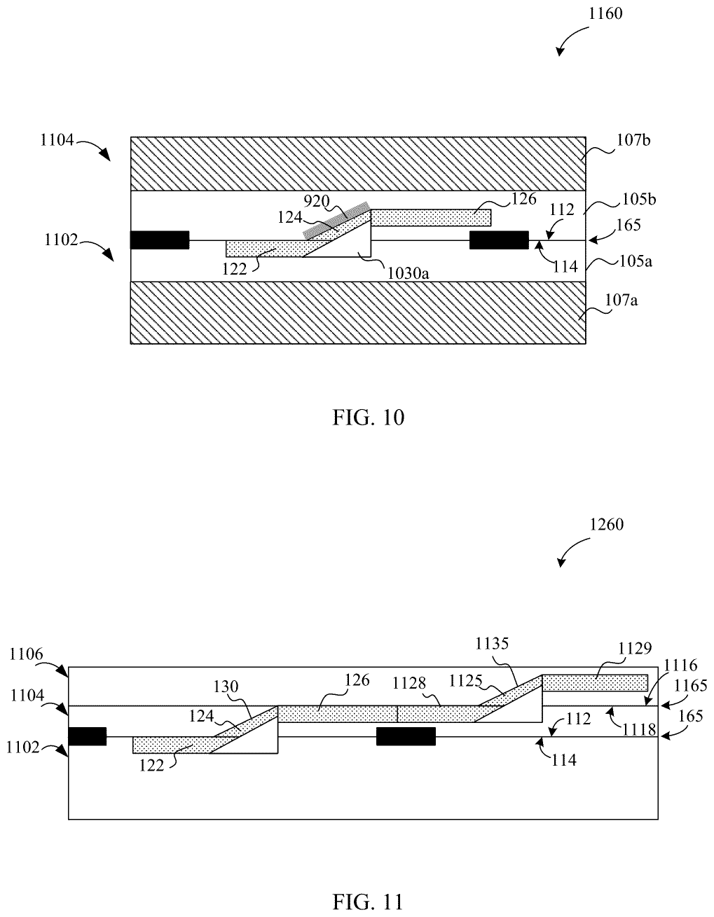

FIG. 10 illustrates a structure 1160 with chips 1102 and 1104 bonded together. The structure 1160 may include the optical waveguide protrusion 124 interfacing the reflective surface of the reflective material 920 similar to the structure 960 described with respect to FIG. 8B, and the air gap 1030a arranged below the optical waveguide protrusion 124 similar to the structure 1060 described with respect to FIG. 9B.

FIG. 11 illustrates a structure 1260 having multiple chips bonded together. In one embodiment, the structure 1260 may include stacked chips 1102, 1104 and 1106. For example, chip 1104 may be an intermediate chip positioned between chip 1102 and chip 1106. The chip 1102 may have first surface 112 and may include the optical component 122 and the optical waveguide protrusion 124 extending above the first surface 112 of the chip 1102. The chip 1104 may have second surface 114 and third surface 1116, and may include groove 130, optical component 126, and optical component 1128. The groove 130 may extend from the second surface 114 and into a portion of the chip 1104. The optical waveguide protrusion 124 of chip 1102 may be positioned in the groove 130 in the chip 1104. The second surface 114 of the chip 1104 may face the first surface 112 of the chip 1102 when the chips 1102 and 1104 are stacked. The chip 1104 may be bonded to the chip 1102 at the bonding interface 165. In some embodiments, the chip 1104 may further include an optical waveguide protrusion 1125 extending above the third surface 1116 of the chip 1104. The optical component 126 and the optical component 1128 may optically couple the optical waveguide protrusion 124 positioned in the groove 130 and the optical waveguide protrusion 1125 extending above the third surface 1116 of the chip 1104. The chip 1106 may have fourth surface 1118 and may include groove 1135 and optical component 1129. The groove 1135 may extend from the fourth surface 1118 and into a portion of the chip 1106. The optical waveguide protrusion 1125 of chip 1104 may be positioned in the groove 1135 in the chip 1106. The chips 1102, 1104 and/or 1106 may include metal wiring. For example, the chip 1104 may be an intermediate chip positioned between chip 1102 and chip 1106, and may include optical components and metal wiring.

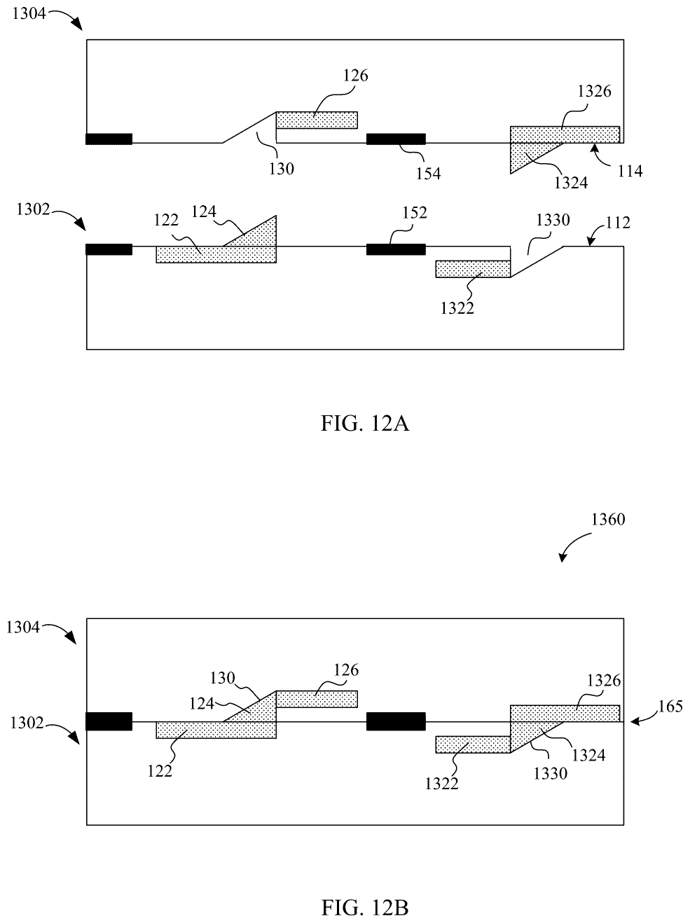

FIGS. 12A-12B illustrate another embodiment of a method for forming a structure in accordance with various embodiments of the invention. In FIGS. 12A-12B, like numerals refer to like elements of the previous figures. For example, the method is similar to those described in FIGS. 1A-1B and FIGS. 3A-3B, but in this case, chip 1302 may include a groove 1330 in addition to the optical waveguide protrusion 124 while chip 1304 may include an optical waveguide protrusion 1324 in addition to the groove 130. The groove 1330 may extend below the first surface 112 of the chip 1302. The groove 1330 may be configured to receive the optical waveguide protrusion 1324 disposed on chip 1304 when the chips 1302 and 1304 are stacked and/or or bonded together with the first surface 112 of the chip 1302 facing the second surface 114 of the chip 1304. The groove 1330 may correspond to a shape of the optical waveguide protrusion 1324. The optical waveguide protrusion 1324 may extend above the second surface 114 of the chip 1304. The chip 1302 may further include optical component 1322 adjacent to the groove 1330. In one embodiment, the optical component 122 and the optical component 1322 may each be optical waveguides which are disposed in different layers or levels of the chip 1302. The chip 1304 may further include optical component 1326 adjacent to the optical waveguide protrusion 1324. In one embodiment, the optical component 126 and the optical component 1326 may each be optical waveguides which are disposed in different layers or levels of the chip 1304. FIG. 12B illustrates a cross-sectional view of a structure 1360 after stacking and/or bonding the chips 1302 and 1304 together, in accordance with various embodiments of the invention. As illustrated, the optical waveguide protrusion 124 is positioned in the groove 130 in the chip 1304, and the optical waveguide protrusion 1324 is positioned in the groove 1330 in the chip 1302.

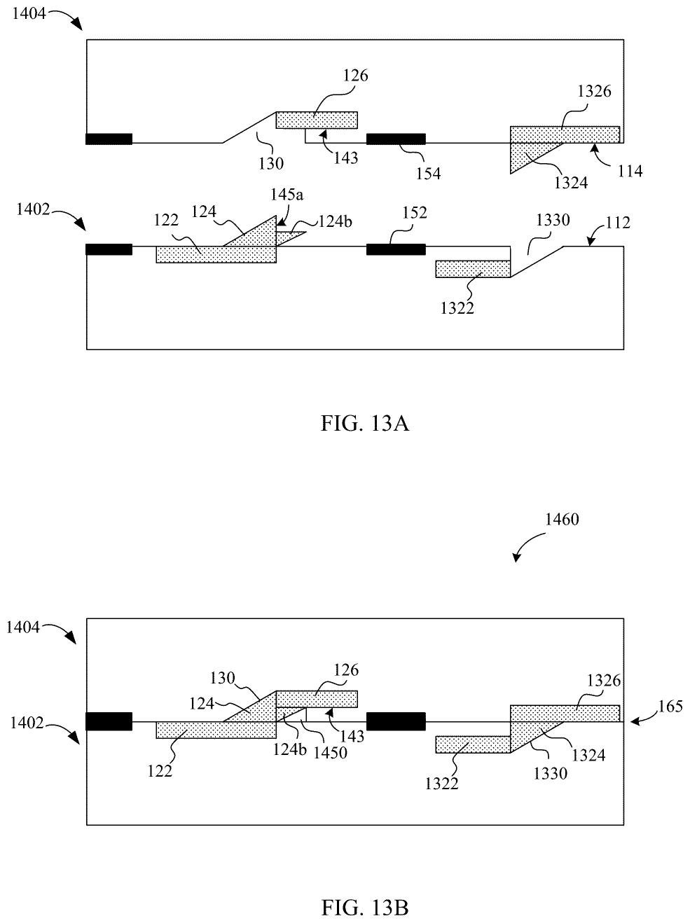

FIGS. 13A-13B illustrate cross-sectional views of chips 1402 and 1404, in which like numerals refer to like elements of the previous figures. In the case the optical component 122 and the optical component 126 are optical waveguides (e.g., first optical waveguide and third optical waveguide, respectively) and the optical waveguide protrusion 124 is a second optical waveguide formed on the top surface of the first optical waveguide, in one embodiment, the optical waveguide protrusion 124 of chip 1402 may include a waveguide extension portion 124b which may extend laterally beyond a side surface of the first optical waveguide. In one embodiment, the waveguide extension portion 124b may be configured to contact a portion of the top surface 143 of the third optical waveguide when the chips 1402 and 1404 are stacked and/or bonded. The waveguide extension portion 124b, for example, may extend laterally from a lower portion of the side surface 145a of the optical waveguide protrusion 124, as illustrated in FIG. 13A. In one embodiment, the waveguide extension portion 124b may include a top surface adjoining a side surface to form a corner having an acute angle. For example, the waveguide extension portion 124b may have a triangular shape with the corner having the acute angle extending laterally from the side surface 145a. The optical waveguide protrusion 124 with the waveguide extension portion 124b may be configured to abut the third optical waveguide when the chips 1402 and 1404 are stacked with an upper portion of the side surface 145a of the optical waveguide protrusion 124 contacting a side surface of the third optical waveguide and the waveguide extension portion 124b contacting a portion of the top surface 143 of the third optical waveguide. In one embodiment, the optical waveguide protrusion 124 and the waveguide extension portion 124b may be formed by depositing the constituent material of the optical waveguide protrusion 124 and the waveguide extension portion 124b, patterning the material into a rectangular shape and subsequently using laser ablation to form the final shapes of the optical waveguide protrusion 124 with the waveguide extension portion 124b (e.g., triangular shapes of the optical waveguide protrusion 124 and the waveguide extension portion 124b of chip 1402 illustrated in FIG. 13A), for example, in the same step from the original rectangular shape. The groove 130 of the chip 1404 may be configured to receive the optical waveguide protrusion 124 with the waveguide extension portion 124b of the chip 1402. The groove 130 may accommodate the optical waveguide protrusion 124 and the waveguide extension portion 124b when the chips 1402 and 1404 are stacked and/or bonded.

FIG. 13B illustrates a cross-sectional view of a structure 1460 after stacking and/or bonding the chips 1402 and 1404 together, in accordance with various embodiments of the invention. The chip 1402 and/or chip 1404 may be moved to align the optical waveguide protrusion 124 with the waveguide extension portion 124b to the groove 130. For example, the alignment may include a vertical movement, or vertical and horizontal movements of the chip 1402 and/or chip 1404 so as to insert the optical waveguide protrusion 124 with the waveguide extension portion 124b into the groove 130 in the chip 404. The optical waveguide protrusion 124 with the waveguide extension portion 124b may be inserted into the groove 130 in the chip 1404 so as to interlock with the groove 130. The optical waveguide protrusion 124 and the waveguide extension portion 124b may abut the optical component 126. As shown in FIG. 13B, the optical waveguide protrusion 124 may abut a side surface of the third optical waveguide, and the waveguide extension portion 124b may abut a portion of the top surface 143 of the third optical waveguide. The waveguide extension portion 124b may minimize reflections and facilitate improved light coupling. The waveguide extension portion 124b may extend laterally beyond a side surface of the first optical waveguide (optical component 122) for improved forward coupling of light by the optical waveguide protrusion 124 to the third optical waveguide (optical component 126). Providing the waveguide extension portion 124b may further minimize insertion loss in the device stack structure. In one embodiment, an air gap 1450 may be formed below the waveguide extension portion 124b when the optical waveguide protrusion 124 with the waveguide extension portion 124b is positioned in the groove 130. As illustrated in FIG. 13B, the air gap 1450 may be formed along a sidewall of the waveguide extension portion 124b when the optical waveguide protrusion 124 with the waveguide extension portion 124b is positioned in the groove 130. The air gap 1450, for example, may be defined by the waveguide extension portion 124b, a dielectric layer of chip 1402 and a dielectric layer of chip 1404. The air gap 1450 may further minimize reflection and optical losses.

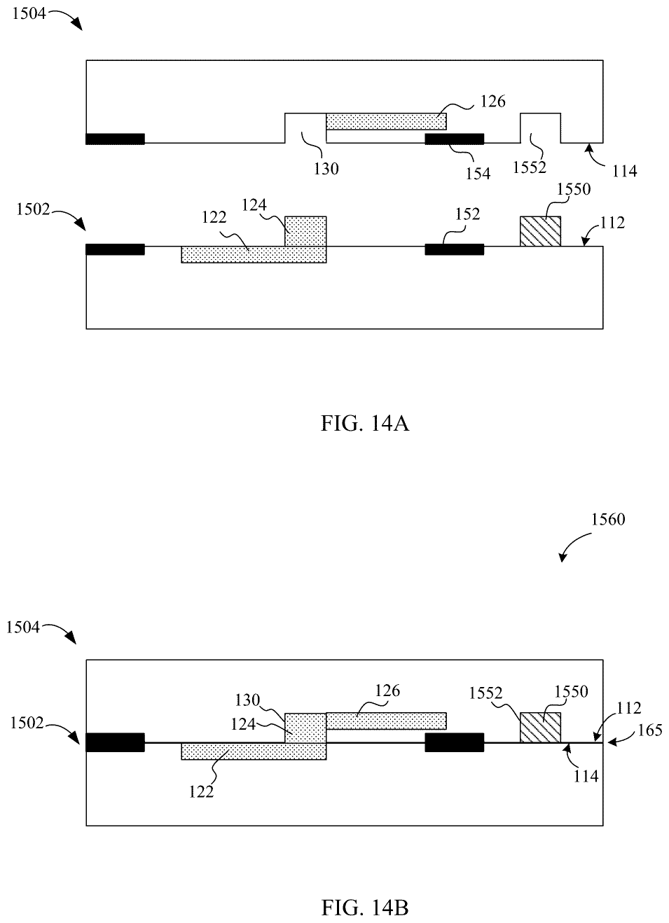

FIGS. 14A-14B illustrate another embodiment of a method for forming a structure in accordance with various embodiments of the invention. In FIGS. 14A-14B, like numerals refer to like elements of the previous figures. For example, the method is similar to those described in FIGS. 1A-1B, but in this case, an alignment structure may be formed on one of the chips which will be stacked and/or bonded together, for example chip 1502, while a second groove corresponding to a shape of the alignment structure may be formed in the other one of the chips, for example chip 1504. For example, alignment structure 1550 may be formed on chip 1502, and a second groove 1552 corresponding to the alignment structure 1550 may be formed in chip 1504, which is depicted as inverted in FIGS. 14A and 14B. The alignment structure 1550 may extend above first surface 112 of the chip 1502. The alignment structure 1550, for example, may have a shape such as cube, cuboid, cylinder, hollow cylinder, 3D spiral or any other basic 3D polygons. The alignment structure 1550 may be a topography alignment structure and need not serve any electrical function and/or optical function. The second groove 1552 may extend below the second surface 114 of the chip 1504. The second groove 1552 may be configured to receive the alignment structure 1550 when the chips 1502 and 1504 are stacked and/or or bonded together with the first surface 112 of the chip 1502 facing the second surface 114 of the chip 1504. The second groove 1552 may correspond to a shape of the alignment structure 1550. The alignment structure 1550 may be formed of metallic, dielectric or semiconductor material. In one embodiment, the alignment structure 1550 may be formed of the same material as the optical waveguide protrusion 124. In some cases, the alignment structure 1550 may facilitate the interlocking of the two chips 1502 and 1504 (allow for self-assembly) by energy minimization of the surface or interface between the two chips 1502 and 1504, which promotes capillary action for covalent bonding between the surfaces. The alignment structure 1550 may be formed, for example, in the same step as the optical waveguide protrusion 124, such as patterned using laser ablation. The alignment structure 1550 may be formed by depositing its constituent material and patterning, for example, using laser ablation with the same or similar process condition for forming the optical waveguide protrusion 124. FIG. 14B illustrates a cross-sectional view of a structure 1560 after stacking and/or bonding the chips 1502 and 1504 together, in accordance with various embodiments of the invention. As illustrated, the alignment structure 1550 may be positioned in the second groove 1552 in the chip 1504. The alignment structure 1550 may facilitate translational (e.g., x-direction, y-direction) and/or rotational alignment between chips 1502 and 1504. Accordingly, the alignment structure 1550 may have better resolution than conventional wafer alignment tools. The alignment structure 1550 may be formed such that it is located nearer to the optical devices of the device stack structure for better alignment.

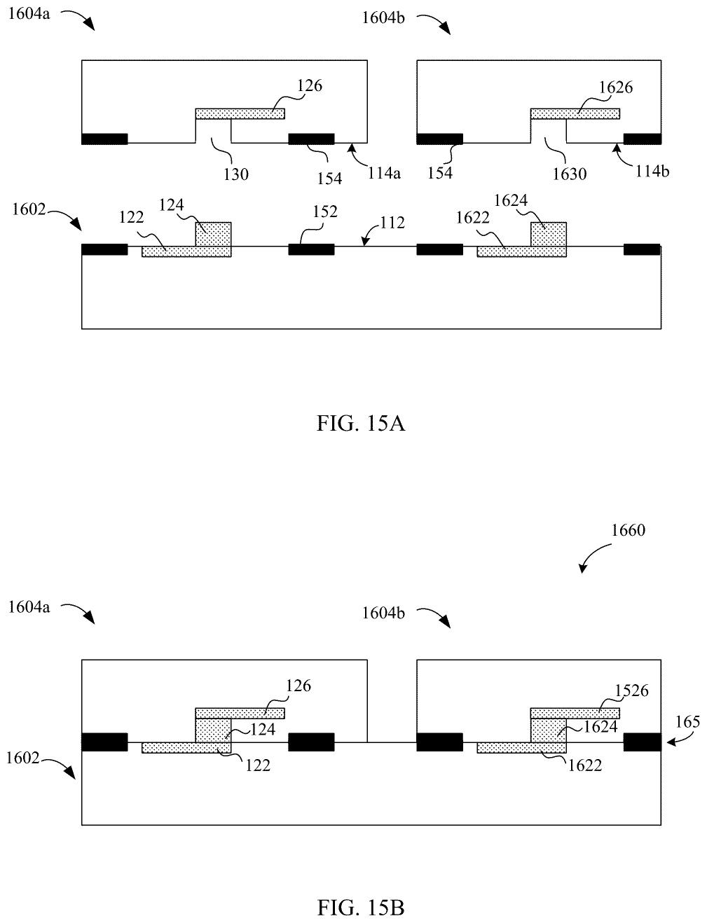

As described, the optical waveguide protrusion 124 may be employed for optically coupling two or more chips vertically stacked together in a device stack, such as in a chip-to-chip bonding process, in a wafer-to-wafer bonding process or chip-to-wafer bonding process. FIGS. 15A-15B illustrate an embodiment of a chip-to-wafer bonding process for forming a structure in accordance with various embodiments of the invention. In FIGS. 15A-15B, like numerals refer to like elements of the previous figures. For example, the method is similar to those described in FIGS. 1A-1B, but in this case, chips 1604a and 1604b which are depicted as inverted in FIGS. 15A and 15B may be provided for stacking and/or bonding to wafer 1602. For example, optical waveguide protrusions may be formed on the wafer 1602, while grooves corresponding to the optical waveguide protrusions may be formed in the chips 1604a and 1604b. Alternatively, optical waveguide protrusions may be formed on the chips 1604a and 1604b, while grooves corresponding to the optical waveguide protrusions may be formed in the wafer 1602. In yet other embodiments, an optical waveguide protrusion may be formed on the wafer 1602 for interlocking with a groove on one of the chips 1604a and 1604b, and a groove may be formed in the wafer 1602 for interlocking with an optical waveguide protrusion on the other one of the chips 1604a and 1604b. For purpose of illustration, wafer 1602 may be provided with optical waveguide protrusions 124 and 1624 extending above the first surface 112 of wafer 1602 for interlocking with groove 130 of chip 1604a and groove 1630 of chip 1604b, respectively. The groove 130 may extend below the second surface 114a of chip 1604a and correspond to the shape of optical waveguide protrusion 124. The groove 1630 may extend below the second surface 114b of chip 1604b and correspond to the shape of optical waveguide protrusion 1624. The wafer 1602 may further include optical component 122 adjacent to the optical waveguide protrusion 124, and optical component 1622 adjacent to the optical waveguide protrusion 1624. The chip 1604a may further include optical component 126 adjacent to the groove 130. The chip 1604b may further include optical component 1626 adjacent to the groove 1630. The optical components 122 and 126 and may be configured to transfer optical signals to or from the optical waveguide protrusion 124, while the optical components 1622 and 1626 may be configured to transfer optical signals to or from the optical waveguide protrusion 1624. In one embodiment, the optical components 122, 126, 1622 and 1626 may be optical waveguides. The optical waveguide protrusion 124 and 1624 and the optical components 122, 126, 1622 and 1626 may be formed of the same material. FIG. 16B illustrates a cross-sectional view of a structure 1660 after stacking and/or bonding the wafer 1602 and the chips 1604a and 1604b together, in accordance with various embodiments of the invention.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A structure comprising:
a first chip having a first surface, and including a first optical component and an optical waveguide protrusion adjacent to the first optical component, the optical waveguide protrusion extending above the first surface of the first chip; and
a second chip having a second surface adjacent to the first surface of the first chip, the second chip including a second optical component and a groove adjacent to the second optical component, the groove extending from the second surface of the second chip and into a portion of the second chip,
wherein the optical waveguide protrusion is positioned in the groove in the second chip.

2. The structure of claim 1, wherein the first optical component is a first optical waveguide and the optical waveguide protrusion is a second optical waveguide of the structure, the second optical waveguide is disposed on the first optical waveguide and abuts a portion of a top surface of the first optical waveguide.

3. The structure of claim 2, wherein the second optical component is a third optical waveguide of the structure, the third optical waveguide abuts the second optical waveguide.

4. The structure of claim 3, wherein the third optical waveguide is arranged laterally adjacent to the second optical waveguide.

5. The structure of claim 3, wherein the third optical waveguide is arranged over the second optical waveguide and a portion of the third optical waveguide overlaps the second optical waveguide.

6. The structure of claim 1, wherein the first optical component is a first optical waveguide and the optical waveguide protrusion is an upper portion of a second optical waveguide, the second optical waveguide further comprises a lower portion extending below the first surface of the first chip, the second optical waveguide is laterally spaced from the first optical waveguide in the first chip, and the second optical waveguide forms a ring resonator.

7. The structure of claim 1, wherein the first chip further includes a first dielectric layer surrounding the first optical component, and the second chip further includes a second dielectric layer surrounding the groove, wherein the second dielectric layer directly contacts the first dielectric layer.

8. The structure of claim 7, wherein a top surface of the first dielectric layer and the first optical component is substantially coplanar, and the second dielectric layer directly contacts at least a portion of the top surface of the first optical component.

9. The structure of claim 1, wherein the first chip further comprises a first bond pad, and the second chip further comprises a second bond pad, the first chip is bonded to the second chip via the first bond pad and the second bond pad.

10. The structure of claim 1, wherein the first optical component and the second optical component are optical waveguides, and the first optical component, the second optical component and the optical waveguide protrusion are formed of the same material.

11. The structure of claim 1, wherein the optical waveguide protrusion partially fills the groove, and further comprising an air gap below the optical waveguide protrusion.

12. The structure of claim 1, further comprising a sealing material between the optical waveguide protrusion and the groove.

13. The structure of claim 1, further comprising a reflective surface along a side of the groove, wherein optical waveguide protrusion interfaces with the reflective surface.

14. The structure of claim 1, wherein the first chip further includes a second groove extending below the first surface of the first chip, and the second chip further includes a second optical waveguide protrusion extending above the second surface of the second chip, and wherein the second optical waveguide protrusion is positioned in the second groove in the first chip.

15. The structure of claim 1, wherein the first chip further comprises an alignment structure extending above the first surface of the first chip, the second chip having a second groove extending below the second surface of the second chip, and wherein the alignment structure is positioned in the second groove in the second chip.

16. A structure comprising:
a first chip including a first optical waveguide, a second optical waveguide arranged on the first optical waveguide, and a first dielectric layer surrounding the first optical waveguide, wherein the second optical waveguide extends above a top surface of the first dielectric layer; and
a second chip stacked over the first chip, the second chip including a second dielectric layer arranged over the first dielectric layer, a third optical waveguide and a groove adjacent to the third optical waveguide in the second dielectric layer, wherein the groove extends from a top surface of the second dielectric layer and into the second dielectric layer,
wherein the second optical waveguide is positioned in the groove in the second chip.

17. The structure of claim 16, wherein the second optical waveguide abuts the first optical waveguide and the third optical waveguide.

18. The structure of claim 17, wherein the second optical waveguide has a first side surface adjoining a second side surface to form a corner of the second optical waveguide having an acute angle.

19. A method, comprising:
forming a first chip having a first surface, and including a first optical component and an optical waveguide protrusion adjacent to the first optical component, the optical waveguide protrusion extending above the first surface of the first chip;
forming a second chip having a second surface and including a second optical component and a groove adjacent to the second optical component, the groove extending from the second surface of the second chip and into a portion of the second chip;
positioning the optical waveguide protrusion in the groove in the second chip; and
bonding the first surface of the first chip to the second surface of the second chip.

20. The method of claim 19, wherein forming the first chip further comprises patterning the optical waveguide protrusion using laser ablation.
